(19) United States
(12) Patent Application Publication
(10) Pub. No.: US 2012/0100476 A1
(43) Pub. Date: Apr. 26, 2012

(54) PRESSURE FIXING TONER AND PREPARATION METHOD THEREOF

(75) Inventors: Wook Jang, Daejeon (KR); Chang-Soon Lee, Daejeon (KR)

(73) Assignee: LG CHEM, LTD., Seoul (KR)

(21) Appl. No.: 13/379,144

(22) PCT Filed: Jun. 16, 2010
(86) PCT No.: PCT/KR2010/003874

§ 371 Date: Dec. 19, 2011

(30) Foreign Application Priority Data
Jun. 19, 2009 (KR) 10-2009-0054785

(51) Int. Cl. G03G 9/093

(52) U.S. Cl. 430/108.2; 430/110.2; 430/108.1; 430/108.4; 430/137.11

(57) ABSTRACT

The present invention relates to a pressure fixing toner which can be fixed at a lower temperature to enable energy-efficient high-speed printing, and a preparation method thereof.

The pressure fixing toner comprises: a core which comprises a wax mixture including a wax and a pigment; and a shell which comprises a polymer or copolymer of at least one kind of polymerizable monomer selected from the group consisting of an aromatic vinyl-based monomer, an acrylate-based monomer, a methacrylate-based monomer and a diene-based monomer, and surrounds the core. The content of the wax of the core is 44-93 parts by weight based on 100 parts by weight of the total toner.

### BACKGROUND OF THE INVENTION

(a) Field of the Invention

The present invention relates to a pressure fixing toner which can be fixed at a lower temperature to enable energy-efficient high-speed printing, and a preparation method thereof.

(b) Description of the Related Art

Toner is used to an electric-photographic printing, an electrostatic printer or copier, and the like, and it designates a coloring material which can be transferred and fixed to an object to be transferred for forming a desired pattern. As the word processing using a computer is generalized recently, the demands for the image forming devices such as a printer is rising rapidly, and accordingly the quantity of the toner consumed is also being increased.

Meanwhile, as methods of forming the toner, there are a pulverization method and a polymerization method. According to the pulverization method, the toner particles are prepared through a melt-mixing process by feeding a resin and a pigment, melt-mixing or extruding, pulverizing, and classifying the same. However, the toner particles prepared by such method have wide distribution of particle diameter and very irregular shape such as the shape having sharp edges, and thus they have had a disadvantage of that electrification or flowability is not good.

For resolving the problem, methods of preparing spherical toner particles by using polymerization have been suggested. As the methods of using polymerization, a method of using emulsion polymerization/coagulation and a method of using suspension polymerization have been known, and the method according to the suspension polymerization is favored because the method according to emulsion polymerization is difficult to control the size distribution of the particles and it has a problem in the reproducibility of the quality of the toner prepared.

However, since the toner formed by the suspension polymerization can realize an image through a high temperature fixation at the temperature of over 100° C. in general, there is a disadvantage of that it is energy-inefficient and the high-speed printing using the same becomes difficult.

### SUMMARY OF THE INVENTION

It is an aspect of the present invention to provide a pressure fixing toner which can be fixed at a lower temperature to enable energy-efficient high-speed printing.

It is another aspect of the present invention to provide a method of preparing the pressure fixing toner.

The present invention provides a pressure fixing toner, comprising: a core which comprises a wax mixture including a wax and a pigment; and a shell which comprises a polymer or copolymer of at least one kind of polymerizable monomer selected from the group consisting of an aromatic vinyl-based monomer, an acrylate-based monomer, a methacrylate-based monomer and a diene-based monomer, and surrounds the core, wherein the content of the wax of the core is 44 to 93 parts by weight based on 100 parts by weight of the total toner.

The present invention also provides a method of preparing the pressure fixing toner, including the steps of: forming a wax mixture including a wax and a pigment; dispersing the wax mixture in an aqueous medium in a form of liquid-drop; adding one or more polymerizable monomers selected from the group consisting of an aromatic vinyl-based monomer, an acrylate-based monomer, a methacrylate-based monomer, and a diene-based monomer to the dispersed solution, and carrying out a suspension polymerization so as to form a shell surrounding the wax mixture dispersed in the form of liquid drop.

### DETAILED DESCRIPTION OF THE EMBODIMENTS

Hereinafter, the pressure fixing toner according to one embodiment of the present invention and the method of preparing the same are explained in more detail.

According to one embodiment of the present invention, a pressure fixing toner comprising: a core which comprises a wax mixture including a wax and a pigment; and a shell which comprises a polymer or copolymer of at least one kind of polymerizable monomer selected from the group consisting of an aromatic vinyl-based monomer, an acrylate-based monomer, a methacrylate-based monomer and a diene-based monomer, and surrounds the core, wherein the content of the wax of the core is 44 to 93 parts by weight based on 100 parts by weight of the total toner is provided.

Such pressure fixing toner includes the core-shell type toner particle that a certain polymer material surrounds the core including the wax, the pigment, and so on, and it includes the wax mixture composing the core, particularly the wax, in the toner particle with the high content of 44 to 93 parts by weight based on 100 parts by weight of the total toner.

Previously, some spherical toner particles having the core-shell structure have been known. However, in the case of previously known toner particles, the core included a binder resin which was mixed with or dispersed in the wax in the core, and a certain polymer material surrounded such core. Accordingly, in previously known toner particles, the polymer components including the binder resin of the core and the polymer material of the shell occupied a respectable amount, for example 70 weight % or more, of the total toner. Due to such high content of the polymer component, the toner particles can be fixed and realize an image at high temperature of over 100° C., and there is a disadvantage of that it is energy-inefficient and the high-speed printing using the same becomes difficult.

However, from the experiments of the present inventors, it is revealed that the core can be formed by only mixing the wax and the pigment and the like without mixing or dispersing the binder resin or the polymerizable monomer for forming the same, and the core-shell type toner particle that a certain polymer material surrounds the core can be obtained.

Since the toner particle is prepared without adding the polymer component like the binder resin, and the shell of a certain polymer material surrounds the core, the content occupied by the polymer component in the total toner can be largely lowered, and thus the content of the wax mixture including the wax and the pigment and the like can be largely increased, and particularly the content of the wax can become largely higher to 44 to 93 parts by weight per 100 parts by weight of the total toner.

As supported by the Examples disclosed later, since the pressure fixing toner including the wax with high content can be fixed and realize an image by pressure at the low fixing temperature, for example, less than 90° C., the high-speed printing becomes possible with higher energy-efficiency by using the pressure fixing toner.

Meanwhile, the specifications of the pressure fixing toner according to one embodiment of the present invention are as follows.

The pressure fixing toner comprises the core composed of the wax mixture including the wax and the pigment and the like without adding the polymer component like the binder resin, and a certain polymer material shell surrounds the core. Accordingly, the wax mixture composing the core, particularly a respectable amount of the wax is not mixed with the polymer component and can exist independently in the core in a dispersed form. Namely, only part of the wax (for example some wax at the interface of the core and the shell) can be mixed with the polymer component like a certain polymer material derived from the shell, the rest wax of considerable amount and the wax mixture including the same is not dispersed in or mixed with the polymer component such as the binder resin and the polymer material of the shell, and it can exist independently and continuously in the core.

For example, a considerable amount of about 50 weight % or more, preferably about 70 weight % or more, more preferably about 80 weight % or more of the wax is not mixed with the polymer component, and can exist independently in the core in a dispersed form. Such pressure fixing toner can be fixed by pressure at a lower fixing temperature, for example the fixing temperature of about less than 90° C., preferably about less than 80° C., and more preferably about less than 70° C., and accordingly makes the energy-effective high-speed printing possible, because of the high content of the wax and the low content of the polymer component in the total toner.

Furthermore, in the pressure fixing toner, the wax component composing the core includes the wax of about 44 to 93 parts by weight, preferably about 60 to 90 parts by weight, and more preferably about 70 to 90 parts by weight based on 100 parts by weight of the total toner. As disclosed above, the fixing temperature of the toner can be lowered largely and the energy-effective high-speed printing is possible because of the high content of the wax.

A natural wax or a synthetic wax which have been used for the toner can be used as the wax without particular limitation. As an example of the wax, there is a paraffin wax, a microcrystalline wax, a ceresin wax, a carnuba wax, an ester-based wax, a polyethylene-based wax, and a polypropylene-based wax, and any one wax or a mixture of two or more waxes selected from these may be used.

Furthermore, various pigments belonged to carbon black, aniline black, a yellow colorant, a magenta colorant, or a cyan colorant may be used as the pigment included with the wax in the wax mixture, and pigments, dyes, or colorants which have been previously known for the toner may be used without particular limitation.

Furthermore, various additives may be included in the wax mixture composing the core in addition to the wax and the pigment, and a charge controlling agent, a cross-linking agent, a molecular weight controlling agent, or a pigment dispersing agent may be used as the additive. The wax mixture may include one additive or two or more additives selected from these as occasion demands.

The charge controlling agent among the additives is a component for controlling the tribo-electrostatic charge, for example, it may be a nigrosin-type acid dye, a high aliphatic metal salt, an alkoxy amine, a chelate, a quaternary ammonium salt, an alkyl amide, a fluorinated activator, a metal naphthalate, an acidic organic complex, a chlorinated paraffin, a chlorinated polyester, a polyester including an acid, a sulfonylamine of copper phthalocyanine, a styrene-acrylic polymer including a sulfonic acid group, and the like, and various charge controlling agents known for the toner may be used without particular limitation.

Furthermore, the pigment dispersing agent is a component for improving the dispersity of the organic pigment in the wax mixture composing the core, for example, the polymer disclosed in Korea Patent Publication No. 2005-0098662, more specifically the polymer having a functional group which can react with the organic pigment may be used. In addition to, various compounds which can improve the dispersity of the pigment may be used as the pigment dispersing agent.

Furthermore, the cross-linking agent and the molecular weight controlling agent are components for assisting the formation of the shell surrounding the core, and some of them may be remained in the wax mixture after the toner is formed. As the cross-linking agent, divinyl benzene, ethylene dimethacrylate, ethyleneglycol dimethacrylate, diethyleneglycol diacrylate, 1,6-hexamethylene diacrylate, allyl methacrylate, 1,1,1-trimethylolpropane triacrylate, triallylamine, or tetraallyloxyethane may be used, or two or more compounds selected from them may be used. Furthermore, various poly-functional compounds which assist the polymerization or the cross-linking of the polymerizable monomer for forming the shell may be used in addition to the compounds. Furthermore, the compounds such as t-dodecyl mercaptane, n-dodecyl mercaptane, n-octyl mercaptane, carbon tetrachloride, carbon tetrabromide, and the like may be used as the molecular weight controlling agent.

The components disclosed above, namely the wax, the pigment, and the selective additives, are included in the pigment mixture composing the core of the toner particle, the pigment mixture may include the wax of about 44 to 93 parts by weight, preferably about 60 to 90 parts by weight, and more preferably about 70 to 90 parts by weight, the pigment of about 2 to 6 parts by weight, and preferably about 3 to 5 parts by weight, and the additive of about 0 to 10 parts by weight, preferably about 3 to 10 parts by weight, and more preferably about 3 to 8 parts by weight, based on 100 parts by weight of the total pressure fixing toner. Furthermore, in the additives, the charge controlling agent may be include with about 0 to 5 parts by weight, and preferably about 1 to 5 parts by weight, the pigment dispersing agent may be included with about 0 to 3 parts by weight, and preferably about 1 to 3 parts by weight, and the cross-linking agent and the molecular weight controlling agent may be included with about 0 to 2 parts by weight, and preferably about 0.5 to 2 parts by weight, based on 100 parts by weight of the total pressure fixing toner. As the pigment mixture composing the core includes these components with above content, the dispersing stability of the pigment mixture in the core can be maintained excellently and the characteristic of the electrificity of the toner can be maintained in a preferable range while the toner including the same can be fixed at a lower temperature.

Meanwhile, the pressure fixing toner according to one embodiment of the present invention includes the shell including a certain polymer material which surrounds the core, in company with the wax mixture composing the core. For example, the pressure fixing toner may include the core of about 50 to 95 parts by weight, preferably about 65 to 93 parts by weight, and more preferably about 75 to 93 parts by weight, the shell of about 5 to 50 parts by weight, preferably 7 to 35 parts by weight, and more preferably 7 to 25 parts by weight based on 100 parts by weight of the total pressure fixing toner, and the polymer material of the shell may be included with about 4 to 50 parts by weight, preferably about 6 to 35 parts by weight, and more preferably about 6 to 25 parts by weight based on 100 parts by weight of the total toner. The shell may include residues such as remaining monomer or initiator of less than about 1 part by weight, preferably less than about 0.5 parts by weight, and more preferably less than about 0.1 parts by weight. As the toner includes the core and the shell with above content, the shell including a certain polymer material as the main component can surround the core properly so that the toner maintains the stable spherical form of the particle, and the content of the wax mixture, particularly the content of the wax, composing the core can be increased and the toner can be fixed and realize an image at a lower temperature.

Furthermore, when the diameter of the single toner particle including the core and the shell is assumed as d, the shell may have the thickness of about 0.05 d to 0.20 d, preferably about 0.05 d to 0.15 d, and more preferably about 0.07 d to 0.13 d. As the shell has such thickness, the shell can surround the core properly so that the toner maintains stable form of the particle, and the low fixing temperature of the toner can be effectively realized and the energy-efficient printing becomes possible.

The polymer material included in the shell of the toner may be a polymer obtained by polymerizing a certain polymerizable monomer such as an aromatic vinyl-based monomer, an acrylate-based monomer, a methacrylate-based monomer, or a diene-based monomer, or a copolymer obtained by copolymerizing two or more monomers selected from them. At this time, as examples of the polymerizable monomer, there are an aromatic vinyl-based monomer such as styrene, monochlorostyrene, methylstyrene, or dimethylstyrene; an acrylate-based monomer such as methyl acrylate, ethyl acrylate, butyl acrylate, dodecyl acrylate, or 2-ethylhexyl acrylate; a methacrylate-based monomer such as methyl methacrylate, ethyl methacrylate, butyl methacrylate, dodecyl methacrylate, 2-ethylhexyl methacrylate; or a diene-based monomer such as butadiene or isoprene. The shell surrounding the core can be effectively formed by polymerizing or copolymerizing such polymerizable monomers.

Furthermore, the polymer or copolymer may be what is obtained by polymerizing or copolymerizing the polymerizable monomer alone, or it may be what is obtained by using an acidic olefin-based monomer or a basic olefin-based monomer selectively in addition to the monomer and polymerizing or copolymerizing the same. At this time, the acidic olefin-based monomer may be α,β-ethylene compounds and the like, and the basic olefin-based monomer may be a methacrylate-based monomer which is a methacrylate of an aliphatic alcohol having an amine group or a quaternary ammonium group, a methyacrylamide-based monomer, a vinylamine-based monomer, a diallylamine-based monomer, or an ammonium salt of the same. Furthermore, such acidic olefin-based monomer or basic olefin-based monomer may be used with the content of about 30 parts by weight or less, suitably about 1 to 30 parts by weight, and preferably 5 to 25 parts by weight to be copolymerized, and can form the polymer or the copolymer included in the shell as the main component.

Furthermore, the polymer or copolymer may be what is formed by polymerizing or copolymerizing the polymerizable monomer and the selective acidic or basic olefin-based monomer in the presence of an initiator. At this time, general radical initiator, for example, azobisisobutyronitrile, azobisvaleronitrile, or a mixture thereof may be used as the initiator, and various radical initiators may be used in addition to. And the initiator may be used with the content of about 1 to 5 parts by weight, and preferably 2 to 4 parts by weight based on 100 parts by weight of the polymerizable monomer. By using the initiator, the polymerizable monomer can be polymerized and can form the shell surrounding the core suitably.

Furthermore, the polymer or copolymer may be what is formed by polymerizing or copolymerizing the polymerizable monomer and the like in the presence of the molecular weight controlling agent, the cross-linking agent, or a mixture of them, selectively. At this time, the cross-linking agent and the molecular weight controlling agent explained above in connection with the core may be used as the cross-linking agent and the molecular weight controlling agent in the same manner. Furthermore, the cross-linking agent may be used with the content of about 0.1 to 2 parts by weight, and preferably 0.5 to 1.5 parts by weight based on 100 parts by weight of the polymerizable monomer, and the molecular weight controlling agent may be used with the content of about 1 to 5 parts by weight, and preferably about 2 to 4 parts by weight based on 100 parts by weight of the polymerizable monomer.

The pressure fixing toner including the components disclosed above with a certain content does not include a binder resin in the core, and the core is composed of the wax mixture including the wax and the pigment, and the shell of a certain polymer material surrounds the core suitably and forms a spherical toner particle. According to such core-shell form, the pressure fixing toner has low content of the polymer component in the total toner and the content of the wax is relatively high. Accordingly, the pressure fixing toner enables the fixation and the image realization at a lower temperature, and enables the energy-effective high-speed printing.

Meanwhile, according to another embodiment of the present invention, the method of preparing the pressure fixing toner disclosed above is provided. Such method of preparing the pressure fixing toner may include the steps of: forming a wax mixture including a wax and a pigment; dispersing the wax mixture in an aqueous medium in a form of liquid-drop; adding one or more polymerizable monomers selected from the group consisting of an aromatic vinyl-based monomer, an acrylate-based monomer, a methacrylate-based monomer, and a diene-based monomer to the dispersed solution, and carrying out a suspension polymerization so as to form a shell surrounding the wax mixture dispersed in the form of liquid drop.

According to the preparation method, the wax mixture including the wax and the pigment is added to and dispersed in the aqueous medium in a form of tiny liquid-drop, and then the suspension polymerization is carried out by adding the polymerizable monomer to the dispersed solution. If such polymerization is carried out, the polymerization is occurred on the wax mixture of the tiny liquid-drop, namely the core, and the shell surrounding the core is formed, and the pressure fixing toner can be prepared as the result.

Particularly, from the experiments of the present inventors, it is revealed that the spherical toner particle that the shell surrounds the wax mixture (the core) satisfactorily can be obtained even though the shell of a certain polymer material is formed through a polymerization after dispersing the wax mixture including just the wax, the pigment, and the selective additives in a form of tiny liquid-drop without mixing or dispersing the binder resin or the polymerizable monomer for forming the same in the wax mixture. Accordingly, the toner can be formed satisfactorily in the state of that the content of the polymer component like the binder resin included in the core is largely reduced and the content of the wax is increased, such toner enables the fixation and the image realization at a lower temperature due to the low content of the polymer component and the high content of the wax.

The preparation method of the pressure fixing toner is explained step by step as follows.

In above preparation method, the wax mixture including the wax, the pigment, and the selective additives is formed at first, and the wax mixture is added to the aqueous medium. At this time, the aqueous medium for dispersing the wax mixture may be obtained by dissolving a dispersion stabilizer into water, with this, the wax mixture can maintain the stable dispersed state in the aqueous medium. As the dispersion stabilizer, calcium phosphate, a silica/polyvinylpyrrolidone complex, magnesium hydroxide, or hydroxyl apatite may be used, and the dispersion stabilizer may be used with about 1 to 10 parts by weight, preferably 2 to 8 parts by weight, and more preferably 3 to 7 parts by weight based on 100 parts by weight of water. Accordingly, the wax mixture can maintain the stable dispersed state in the aqueous medium and the dispersion stabilizer can be easily eliminated later.

Furthermore, the overall composition of the wax mixture and the kinds of the selective additives which can be added selectively to the wax mixture are same as disclosed above, the wax mixture may be formed by mixing each component according to the composition.

And, after adding the wax mixture to the aqueous medium, the wax mixture in the aqueous medium is uniformly dispersed in a form of tiny liquid-drop, and such tiny liquid-drops of the wax mixture form the cores in the finally prepared toner. At this time, a homogenizing method providing a shearing force to the mixture solution of the wax mixture and the aqueous medium with a homogenizer may be used for dispersing the liquid-drops. For example, the wax mixture may be dispersed in the aqueous medium in a form of tiny liquid-drop by homogenizing the mixture with the homogenizer with the speed of about 10000 to 20000 rpm, preferably about 10000 to 17000 rpm, and more preferably about 12000 to 16000 rpm.

After then, certain polymerizable monomers such as the aromatic vinyl-based monomer, the acrylate-based monomer, the methacrylate-based monomer, or the diene-based monomer, and selectively, the initiator, the cross-linking agent, the molecular weight controlling agent, the acidic or basic olefin-based monomer, and the like are added to the dispersed solution and the suspension polymerization is carried out. At this time, the kinds of usable initiator, cross-linking agent, molecular weight controlling agent, acidic or basic olefin-based monomer, and the like and the amount used are same as disclosed above.

By carrying out the suspension polymerization, the polymerizable monomer and the like is polymerized into a certain polymer or copolymer while surrounding the wax mixture dispersed in a form of tiny liquid-drop. According to the formation of the polymer or copolymer, the shell including the same as the main component is formed and the core-shell type toner particle can be formed as the result. In such process of forming the shell, for example, the suspension polymerization may be carried out at the temperature of about 50 to 80° C., and preferably about 60 to 75° C. for about 1 to 20 hours, and preferably about 5 to 18 hours, hereby the shell including the polymer or copolymer can be formed suitably.

Meanwhile, after the core-shell type toner particle is formed through the suspension polymerization disclosed above, the steps of eliminating the dispersion stabilizer by washing the toner particles, and drying the toner particles may be further carried out, and the pressure fixing toner according to one embodiment of the present invention can be prepared as the result.

At this time, the step of eliminating the dispersion stabilizer, for example calcium phosphate, may be carried out according to the method of dissolving the dispersion stabilizer in the aqueous solution for separating the dispersion stabilizer from the toner particles by adjusting pH of the solution to be less than 2 by adding an acid to the aqueous dispersion solution in which the toner particles are formed. After eliminating the dispersion stabilizer according to the method, the steps of eliminating moisture through a filtering device, adding an excessive distilled water thereto again for dilution, and eliminating moisture may be repeated several times.

And then, the pressure fixing toner may be prepared by the method of vacuum drying the toner cake in a vacuum oven at room temperature.

In addition, separate external additive, for example silica and the like, may be coated on the surface of the toner as occasion demands, and such coating step of the external additive may be carried out according to the method of adding the external additive to the toner particles by using a hansel mixer, and stirring the same with high-speed.

Through the method disclosed above, the pressure fixing toner according to one embodiment of the present invention comprising the wax mixture core including high content of the wax, the pigment, and the selective additives without a binder resin, and the shell of a certain polymer material surrounding such core can be prepared.

According to the present invention, the pressure fixing toner which can be fixed and can realize an image by pressure at a lower temperature, and a preparation method thereof can be provided.

Therefore, by using the pressure fixing toner, the energy-efficient high-speed printing becomes possible.

### EXAMPLES

Hereinafter, the function and effect of the invention are explained in more detail through concrete examples of the present invention. However, the following examples are only for illustrating the present invention, and the scope of the present invention is not determined to or by them.

### Example 1

(Preparation of Toner)

An aqueous dispersion solution was prepared by adding 5 parts by weight of calcium phosphate as the dispersion stabilizer to 400 parts by weight of ion exchanged water, stirring the same at room temperature for 10 minutes, and elevating the temperature to 70° C. and further stirring the same for 20 minutes.

After 82 parts by weight of the paraffin-based wax was heated to 70° C. by using an water bath, an wax mixture was prepared by adding 4 parts by weight of a pigment and 4 parts by weight of a styrene-acrylic polymer including a sulfonic acid group as the charge controlling agent thereto and stirring the same with high speed.

The wax mixture was added to the aqueous dispersion solution and dispersed in a form of tiny liquid-drop by homogenizing the same by using a homogenizer with the speed of 13000 rpm. After then, 7.5 parts by weight of styrene, 2.5 parts by weight of n-butyl acrylate, and 0.3 parts by weight of azobisisobutyronitrile were mixed while being stirred by a paddle-type stirrer with 200 rpm, and the polymerization was carried out while the mixture was added slowly to the reactor so as to surround the wax mixture dispersed in a form of tiny liquid-drop. The polymerization was carried out for 15 hours and the core-shell type toner particles that the shell of a certain polymer material surrounded the wax mixture (the core) of a form of tiny liquid-drops were obtained.

(Elimination of Dispersion Stabilizer and Drying)

Calcium phosphate was separated from the toner by a proper method in the solution including the toner particles prepared above. More specifically, calcium phosphate was dissolved in the aqueous solution by adjusting pH of the solution to be less than 2 by adding an acid to the aqueous dispersion solution including the toner particles and calcium phosphate. After eliminating moisture by using a filtering device, the processes of adding distilled water thereto again for dilution with 1000 times of 100 parts by weight of solid content of the toner, stirring the same again, and eliminating moisture were repeated 5 times. Finally, the toner was prepared by eliminating moisture through filtering, and vacuum drying the toner cake at room temperature in a vacuum oven.

(External Additive Coating)

The external additive of silica was coated on the surface of the toner particle by adding 2 parts by weight of silica to 100 parts by weight of the toner by using a hansel mixer, and stirring the same with the high speed of 5000 rpm for 7 minutes. According to this, the pressure fixing toner of Example 1 was prepared.

The volume average diameter of the toner particles in the toner prepared like this was 7 micron, and the ratio of the volume average diameter and the number average diameter was 1.26. Furthermore, it was recognized that the toner of Example 1 included 90 parts by weight of the wax mixture composing the core and 10 parts by weight of the shell including the polymer material, the wax mixture included 82 parts by weight of the wax, 4 parts by weight of the pigment, and 4 parts by weight of the charge controlling agent, and the shell included 9.9 parts by weight of the polymer material, and 0.1 parts by weight of the other residues (the remaining monomer, the initiator and the like), based on 100 parts by weight of the total toner.

### Example 2

The pressure fixing toner of Example 2 was prepared substantially according to the same method as in Example 1, except that the amount of the wax used was 72 parts by weight, and 15 parts by weight of styrene, 5 parts by weight of n-butyl acrylate, and 0.7 parts by weight of azobisisobutyronitrile were used for forming the shell. As the result of identifying the composition of the toner particles included in the pressure fixing toner according to the same method as in Example 1, it was recognized that the toner of Example 2 included 80 parts by weight of the wax mixture composing the core and 20 parts by weight of the shell including the polymer material, the wax mixture included 72 parts by weight of the wax, 4 parts by weight of the pigment, and 4 parts by weight of the charge controlling agent, and the shell included 19.7 parts by weight of the polymer material, and 0.3 parts by weight of the other residues (the remaining monomer, the initiator and the like), based on 100 parts by weight of the total toner.

### Example 3

The pressure fixing toner of Example 3 was prepared substantially according to the same method as in Example 1, except that the amount of the wax used was 62 parts by weight, and 22.5 parts by weight of styrene, 7.5 parts by weight of n-butyl acrylate, and 1 part by weight of azobisisobutyronitrile were used for forming the shell. As the result of identifying the composition of the toner particles included in the pressure fixing toner according to the same method as in Example 1, it was recognized that the toner of Example 3 included 70 parts by weight of the wax mixture composing the core and 30 parts by weight of the shell including the polymer material, the wax mixture included 62 parts by weight of the wax, 4 parts by weight of the pigment, and 4 parts by weight of the charge controlling agent, and the shell included 29.5 parts by weight of the polymer material, and 0.5 parts by weight of the other residues (the remaining monomer, the initiator and the like), based on 100 parts by weight of the total toner.

### Example 4

The pressure fixing toner of Example 4 was prepared substantially according to the same method as in Example 1, except that the amount of the wax used was 52 parts by weight, and 30 parts by weight of styrene, 10 parts by weight of n-butyl acrylate, and 1.8 parts by weight of azobisisobutyronitrile were used for forming the shell. As the result of identifying the composition of the toner particles included in the pressure fixing toner according to the same method as in Example 1, it was recognized that the toner of Example 4 included 60 parts by weight of the wax mixture composing the core and 40 parts by weight of the shell including the polymer material, the wax mixture included 52 parts by weight of the wax, 4 parts by weight of the pigment, and 4 parts by weight of the charge controlling agent, and the shell included 39.2 parts by weight of the polymer material, and 0.8 parts by weight of the other residues (the remaining monomer, the initiator and the like), based on 100 parts by weight of the total toner.

### Example 5

The pressure fixing toner of Example 5 was prepared substantially according to the same method as in Example 1, except that the amount of the wax used was 44 parts by weight, each amount of the pigment and the charge controlling agent used was 3 parts by weight, and 37.5 parts by weight of styrene, 12.5 parts by weight of n-butyl acrylate, and 2.5 parts by weight of azobisisobutyronitrile were used for forming the shell. As the result of identifying the composition of the toner particles included in the pressure fixing toner according to the same method as in Example 1, it was recognized that the toner of Example 5 included 50 parts by weight of the wax mixture composing the core and 50 parts by weight of the shell including the polymer material, the wax mixture included 44 parts by weight of the wax, 3 parts by weight of the pigment, and 3 parts by weight of the charge controlling agent, and the shell included 49.1 parts by weight of the polymer material, and 0.9 parts by weight of the other residues (the remaining monomer, the initiator and the like), based on 100 parts by weight of the total toner.

### Reference Example 1

The pressure fixing toner of Reference Example 1 was prepared substantially according to the same method as in Example 1, except that the amount of the wax used was 32 parts by weight, and 45 parts by weight of styrene, 15 parts by weight of n-butyl acrylate, and 2 parts by weight of azobisisobutyronitrile were used for forming the shell. As the result of identifying the composition of the toner particles included in the pressure fixing toner according to the same method as in Example 1, it was recognized that the toner of Reference Example 1 included 40 parts by weight of the wax mixture composing the core and 60 parts by weight of the shell including the polymer material, the wax mixture included 32 parts by weight of the wax, 4 parts by weight of the pigment, and 4 parts by weight of the charge controlling agent, and the shell included 59.3 parts by weight of the polymer material, and 0.7 parts by weight of the other residues (the remaining monomer, the initiator and the like), based on 100 parts by weight of the total toner.

### Reference Example 2

The pressure fixing toner of Reference Example 2 was prepared substantially according to the same method as in Example 1, except that the amount of the wax used was 40 parts by weight, each amount of the pigment and the charge controlling agent used was 5 parts by weight, and 37.5 parts by weight of styrene, 12.5 parts by weight of n-butyl acrylate, and 2.5 parts by weight of azobisisobutyronitrile were used for forming the shell. As the result of identifying the composition of the toner particles included in the pressure fixing toner according to the same method as in Example 1, it was recognized that the toner of Reference Example 2 included 50 parts by weight of the wax mixture composing the core and 50 parts by weight of the shell including the polymer material, the wax mixture included 40 parts by weight of the wax, 5 parts by weight of the pigment, and 5 parts by weight of the charge controlling agent, and the shell included 49.2 parts by weight of the polymer material, and 0.8 parts by weight of the other residues (the remaining monomer, the initiator and the like), based on 100 parts by weight of the total toner.

### Reference Example 3

The pressure fixing toner of Reference Example 3 was prepared substantially according to the same method as in Example 1, except that the amount of the wax used was 22 parts by weight, and 52.5 parts by weight of styrene, 17.5 parts by weight of n-butyl acrylate, and 3 parts by weight of azobisisobutyronitrile were used for forming the shell. As the result of identifying the composition of the toner particles included in the pressure fixing toner according to the same method as in Example 1, it was recognized that the toner of Reference Example 1 included 30 parts by weight of the wax mixture composing the core and 70 parts by weight of the shell including the polymer material, the wax mixture included 22 parts by weight of the wax, 4 parts by weight of the pigment, and 4 parts by weight of the charge controlling agent, and the shell included 68.4 parts by weight of the polymer material, and 1.6 parts by weight of the other residues (the remaining monomer, the initiator and the like), based on 100 parts by weight of the total toner.

### Experimental Example

(Fixing Temperature of Toner)

After printing the toner on papers with varying the temperature of fixing roll of HP2600 printer, the fixing temperature was determined as the minimum temperature at which the toner was not smeared when the printed paper was rubbed up and down by a curved paper while being pressed with the pressure of 1 Kg. The fixing temperature of Examples and Reference Examples was measured according to such method and the results are listed in following Table

| | Weight ratio | | | Charge | |
|---|---|---|---|---|---|
| | of | | | controlling | |
| | wax | Wax | Pigment | agent | Fixing |
| | mixture/ | (parts by | (parts by | (parts by | temperature |
| | shell | weight) | weight) | weight) | (0° C.) |
| Example 1 | 90/10 | 82 | 4 | 4 | 50 |
| Example 2 | 80/20 | 72 | 4 | 4 | 55 |
| Example 3 | 70/30 | 62 | 4 | 4 | 67 |
| Example 4 | 60/40 | 52 | 4 | 4 | 84 |
| Example 5 | 50/50 | 44 | 3 | 3 | 89 |
| Reference | 40/60 | 32 | 4 | 4 | 130 |
| Example 1 | | | | | |
| Reference | 50/50 | 40 | 5 | 5 | 115 |
| Example 2 | | | | | |
| Reference | 30/70 | 22 | 4 | 4 | 138 |
| Example 3 | | | | | |

Referring Table 1, it is recognized that the toners of Examples 1 to 5 which include the wax with high content of 44 to 82 parts by weight based on 100 parts by weight of the total toner show low fixing temperature of 90° C. or less. Particularly, it is recognized that the fixing temperature of the toners of Examples 1 to 3 of which the content of the wax is over 60 parts by weight is largely lowered to less than 70° C.

In comparison to this, the toners of Reference Examples 1 to 3 show high fixing temperature of minimum 110° C. or more, and thus it is energy-inefficient and the high-speed printing using the same becomes difficult.

1. A pressure fixing toner, comprising:
a core which comprises a wax mixture including a wax and a pigment; and
a shell which comprises a polymer or copolymer of at least one kind of polymerizable monomer selected from the group consisting of an aromatic vinyl-based monomer, an acrylate-based monomer, a methacrylate-based monomer and a diene-based monomer, and surrounds the core,
wherein the content of the wax of the core is 44 to 93 parts by weight based on 100 parts by weight of the total toner.

2. The pressure fixing toner according to claim 1, wherein 50 weight % or more of the wax is not mixed with the polymer component, and is independently dispersed in the core.

3. The pressure fixing toner according to claim 1, wherein the content of the wax of the core is 60 to 90 parts by weight based on 100 parts by weight of the total toner.

4. The pressure fixing toner according to claim 1, representing the fixing temperature of less than 90° C.

5. The pressure fixing toner according to claim 1, wherein the shell has the thickness of 0.05 d to 0.20 d in comparison with the diameter d of a single toner particle including the core and the shell.

6. The pressure fixing toner according to claim 1, wherein the content of the polymer or copolymer of the shell is 4 to 50 parts by weight based on 100 parts by weight of the total toner.

7. The pressure fixing toner according to claim 1, wherein the wax includes one or more waxes for toner selected from the group consisting of a paraffin wax, a microcrystalline wax, a ceresin wax, a carnuba wax, an ester-based wax, a polyethylene-based wax, and a polypropylene-based wax.

8. The pressure fixing toner according to claim 1, wherein the pigment includes one or more pigments for toner selected from the group consisting of carbon black, aniline black, a yellow colorant, a magenta colorant, and a cyan colorant.

9. The pressure fixing toner according to claim 1, wherein wax mixture further includes one or more additives selected from the group consisting of a charge controlling agent, a cross-linking agent, a molecular weight controlling agent, and a pigment dispersing agent.

10. The pressure fixing toner according to claim 9, wherein the charge controlling agent includes one or more tribo-electrostatic charge controlling agent selected from the group consisting of a nigrosin-type acid dye, a high aliphatic metal salt, an alkoxy amine, a chelate, a quaternary ammonium salt, an alkyl amide, a fluorinated activator, a metal naphthalate, an acidic organic complex, a chlorinated paraffin, a chlorinated polyester, a polyester including an acid, a sulfonylamine of copper phthalocyanine, and a styrene-acrylic polymer including a sulfonic acid group.

11. The pressure fixing toner according to claim 9, wherein the wax mixture includes 44 to 93 parts by weight of the wax, 2 to 6 parts by weight of the pigment, and 0 to 10 parts by weight of the additives based on 100 parts by weight of the total toner.

12. The pressure fixing toner according to claim 1, wherein the polymer or copolymer is obtained by polymerizing the polymerizable monomers in the presence of 1 to 5 parts by weight of the initiator based on 100 parts by weight of the polymerizable monomers.

13. The pressure fixing toner according to claim 12, wherein the initiator includes a radical initiator of azobisisobutyronitrile, azobisvaleronitrile, or a mixture thereof.

14. The pressure fixing toner according to claim 1, wherein the polymer or copolymer is obtained by polymerizing the polymerizable monomers in the presence of 1 to 5 parts by weight of the molecular weight controlling agent, 0.1 to 2 parts by weight of the cross-linking agent, or a mixture thereof based on 100 parts by weight of the polymerizable monomers.

15. The pressure fixing toner according to claim 9, wherein
the cross-linking agent includes one or more poly-functional compounds selected from the group consisting of divinyl benzene, ethylene dimethacrylate, ethyleneglycol dimethacrylate, diethyleneglycol diacrylate, 1,6-hexamethylene diacrylate, allyl methacrylate, 1,1,1-trimethylolpropane triacrylate, triallylamine, and tetraallyloxyethane, and
the molecular weight controlling agent includes one or more compounds selected from the group consisting of t-dodecyl mercaptane, n-dodecyl mercaptane, n-octyl mercaptane, carbon tetrachloride, and carbon tetrabromide.

16. The pressure fixing toner according to claim 1, wherein the polymer or copolymer is obtained by polymerizing the polymerizable monomers by further using 1 to 30 parts by weight of an acidic olefin-based monomer or a basic olefin-based monomer based on 100 parts by weight of the polymerizable monomers.

17. A method of preparing the pressure fixing toner according to claim 1, including the steps of:
forming a wax mixture including a wax and a pigment;
dispersing the wax mixture in an aqueous medium in a form of liquid-drop;
adding one or more polymerizable monomers selected from the group consisting of an aromatic vinyl-based monomer, an acrylate-based monomer, a methacrylate-based monomer, and a diene-based monomer to the dispersed solution, and carrying out a suspension polymerization so as to form a shell surrounding the wax mixture dispersed in the form of liquid drop.

18. The method according to claim 17, wherein the aqueous medium is formed by dissolving a dispersion stabilizer into water.

19. The method according to claim 18, wherein the dispersion stabilizer includes calcium phosphate, a silica/polyvinylpyrrolidone complex, magnesium hydroxide, or hydroxyl apatite.

20. The method according to claim 18, wherein the dispersion stabilizer is used with the amount of 1 to 10 parts by weight based on 100 parts by weight of water.

21. The method according to claim 17, wherein the step of dispersing the wax mixture to be liquid drops includes the steps of mixing the wax mixture and the aqueous medium, and homogenizing the mixed solution by using a homogenizer with the speed of 10000-20000 rpm.

22. The method according to claim 18, further including the steps of eliminating the dispersion stabilizer by washing the toner particles, and drying the toner particles, after the step of forming the shell.

23. The pressure fixing toner according to claim 14, wherein
the cross-linking agent includes one or more poly-functional compounds selected from the group consisting of divinyl benzene, ethylene dimethacrylate, ethyleneglycol dimethacrylate, diethyleneglycol diacrylate, 1,6-hexamethylene diacrylate, allyl methacrylate, 1,1,1-trimethylolpropane triacrylate, triallylamine, and tetraallyloxyethane, and
the molecular weight controlling agent includes one or more compounds selected from the group consisting of t-dodecyl mercaptane, n-dodecyl mercaptane, n-octyl mercaptane, carbon tetrachloride, and carbon tetrabromide.
